(19) United States
(12) Patent Application Publication
(10) Pub. No.: US 2026/0001385 A1
(43) Pub. Date: Jan. 1, 2026

(54) VEHICLE AIR CONDITIONER OPERATION CONTROL METHOD, CONTROLLER, AIR CONDITIONER AND RECREATIONAL VEHICLE

(71) Applicant: GD MIDEA AIR-CONDITIONING EQUIPMENT CO., LTD., Foshan (CN)

(72) Inventor: Hui YU, Foshan (CN)

(21) Appl. No.: 18/880,797

(22) PCT Filed: Mar. 27, 2023
(86) PCT No.: PCT/CN2023/084113

§ 371 Date: Jan. 2, 2025

(30) Foreign Application Priority Data
Jul. 13, 2022 (CN) 202210820199.7

(51) Int. Cl. B60H 1/32; B60H 1/00; F24F 11/46; F24F 11/86

(52) U.S. Cl. CPC B60H 1/3216; B60H 1/00735; F24F 11/46; F24F 11/86

(57) ABSTRACT

A control method includes obtaining an operating instruction including a set operating duration, determining a first maximum operating power of an air conditioner of a vehicle according to the set operating duration and a current remaining charge of a battery of the vehicle, controlling the air conditioner to operate in a power range not exceeding the first maximum operating power, recording a continuous operating duration of the air conditioner and obtaining a real-time remaining charge of the battery, determining a second maximum operating power of the air conditioner according to the continuous operating duration and the real-time remaining charge, and controlling the air conditioner to continue operating in a power range not exceeding the second maximum operating power.

### CROSS-REFERENCE TO RELATED APPLICATION

This application claims priority to Chinese patent application No. 202210820199.7 filed Jul. 13, 2022, entitled “VEHICLE AIR CONDITIONER OPERATION CONTROL METHOD, CONTROLLER, AIR CONDITIONER AND RECREATIONAL VEHICLE,” the entire contents of which are incorporated herein by reference.

### TECHNICAL FIELD

The present disclosure relates to the technical field of air conditioners, and in particular, to a method for controlling operation of a vehicle air conditioner, a controller, an air conditioner, and a recreational vehicle.

### BACKGROUND

An onboard vehicle air conditioner can provide a comfortable experience for the users during travel. Particularly, a recreational vehicle equipped with an air conditioner can allow the user to sleep in the recreational vehicle for a long time at night. However, the power of the air conditioner of the recreational vehicle is generally high, and the battery of the recreational vehicle has limited electricity and may fail to support the long operating duration of the air conditioner, affecting the user's sleep.

### SUMMARY

Embodiments of the present disclosure provide a method for controlling operation of a vehicle air conditioner, a controller, an air conditioner, and a recreational vehicle, to use limited electricity in the battery to meet the user's requirement on the operating duration of the vehicle air conditioner.

In accordance with a first aspect of the present disclosure, an embodiment provides a method for controlling operation of a vehicle air conditioner, including:
obtaining an operating instruction from a user, which includes a set operating duration;
determining a first maximum operating power of the air conditioner according to the set operating duration and a current remaining charge of a battery in the vehicle;
controlling the air conditioner to operate within a range not exceeding the first maximum operating power; and
recording a continuous operating duration of the air conditioner, obtaining a real-time remaining charge of the battery, determining a second maximum operating power of the air conditioner according to the continuous operating duration and the real-time remaining charge, and controlling the air conditioner to continue operating within a range not exceeding the second maximum operating power.

The method for controlling operation of a vehicle air conditioner according to the embodiment of the first aspect of the present disclosure at least has the following beneficial effects. To meet the user's requirement on a usage duration of the air conditioner when the remaining charge of the battery in the vehicle is limited, the maximum operating power of the air conditioner is limited according to the set operating duration and the remaining charge of the battery, such that the air conditioner will not stop operation during the set operating duration due to exhaustion of the charge of the battery. In addition, during operation of the air conditioner, the continuous operating duration and the real-time remaining charge of the battery are also recorded, the maximum operating power of the air conditioner is recalculated, and the operation of the air conditioner is limited according to the recalculated maximum operating power, to ensure that the air conditioner can operate for the set operating duration and make full use of the remaining charge of the battery, thereby improving user experience of the vehicle air conditioner.

In some embodiments, determining a first maximum operating power of the air conditioner according to the set operating duration and a current remaining charge of a battery in the vehicle includes:
obtaining the current remaining charge of the battery in the vehicle;
determining a first maximum electricity consumption per unit time of the air conditioner according to the current remaining charge and the set operating duration; and
calculating the first maximum operating power of the air conditioner according to the first maximum electricity consumption.

In some embodiments, controlling the air conditioner to operate within a range not exceeding the first maximum operating power includes:
determining a first maximum compressor frequency and a first maximum fan speed of the air conditioner according to the first maximum operating power; and
limiting a compressor frequency of the air conditioner during operation from exceeding the first maximum compressor frequency, and a fan speed of the air conditioner during operation from exceeding the first maximum fan speed.

In some embodiments, controlling the air conditioner to operate within a range not exceeding the first maximum operating power includes:
controlling a sum of a compressor operating power and a fan operating power of the air conditioner not to exceed a first operating power threshold, where the first operating power threshold is less than the first maximum operating power.

In some embodiments, recording of the continuous operating duration of the air conditioner and obtaining of the real-time remaining charge of the battery are performed at an interval of one hour.

In some embodiments, determining a second maximum operating power of the air conditioner according to the continuous operating duration and the real-time remaining charge includes:
determining a remaining operating duration according to the continuous operating duration and the set operating duration; and
determining the second maximum operating power of the air conditioner according to the remaining operating duration and the real-time remaining charge.

In some embodiments, determining the second maximum operating power of the air conditioner according to the remaining operating duration and the real-time remaining charge includes:
determining a second maximum electricity consumption per unit time of the air conditioner according to the remaining operating duration and the real-time remaining charge; and
calculating the second maximum operating power of the air conditioner according to the second maximum electricity consumption.

In some embodiments, controlling the air conditioner to continue operating within a range not exceeding the second maximum operating power includes:
determining a second maximum compressor frequency and a second maximum fan speed of the air conditioner according to the second maximum operating power; and
limiting a compressor frequency of the air conditioner during operation from exceeding the second maximum compressor frequency, and a fan speed of the air conditioner during operation from exceeding the second maximum fan speed.

In some embodiments, controlling the air conditioner to continue operating within a range not exceeding the second maximum operating power includes:
controlling a sum of a compressor operating power and a fan operating power of the air conditioner not to exceed a second operating power threshold, where the second operating power threshold is less than the second maximum operating power.

In accordance with a second aspect of the present disclosure, an embodiment provides a controller, including a memory, a processor, and a computer program stored in the memory and executable by the processor. The computer program, when executed by the processor, causes the processor to implement the method in accordance with the first aspect.

In accordance with a third aspect of the present disclosure, an embodiment provides an air conditioner, including the controller in accordance with the second aspect.

In accordance with a fourth aspect of the present disclosure, an embodiment provides a computer-readable storage medium, storing a computer-executable instruction which, when executed by a processor, causes the processor to implement the method in accordance with the first aspect.

Additional features and advantages of the disclosure will be set forth in the description which follows, and in part will be obvious from the description, or may be learned by the practice of the disclosure. The objects and other advantages of the present disclosure can be realized and obtained by the structures particularly pointed out in the description, claims and drawings.

### BRIEF DESCRIPTION OF DRAWINGS

FIG. 1 is an overall flowchart of a method for controlling operation according to an embodiment of the present disclosure;

FIG. 2 is a flowchart of calculating a first maximum operating power according to an embodiment of the present disclosure;

FIG. 3 is a flowchart of calculating a first maximum compressor frequency and a first maximum fan speed according to an embodiment of the present disclosure;

FIG. 4 is a flowchart of calculating a second maximum operating power according to an embodiment of the present disclosure;

FIG. 5 is a flowchart of calculating the second maximum operating power according to an embodiment of the present disclosure;

FIG. 6 is a flowchart for calculating a second maximum compressor frequency and the second maximum fan speed according to an embodiment of the present disclosure;

FIG. 7 is an overall flowchart of a method for controlling operation according to an example of the present disclosure; and

FIG. 8 is a structural connection diagram of a controller according to an embodiment of the present disclosure.

### DETAILED DESCRIPTION

Objectives, technical schemes, and advantages of the present disclosure will be clearer from a detailed description of embodiments of the present disclosure in conjunction with accompanying drawings. It should be understood that the embodiments described herein are merely used to illustrate the present disclosure, and are not intended to limit the present disclosure. In addition, the characteristics, operations, or features described in the description may be combined in any suitable manner to form various embodiments. Moreover, the order of steps or actions in the description of the method may be changed or adjusted in a manner apparent to those having ordinary skills in the art. Therefore, the orders in the description and drawings are merely for the purpose of clearly describing a particular embodiment, and are not meant to be necessary orders unless otherwise specified that a particular order must be followed.

In the description of the present disclosure, the term “at least one” means one or more, the term “plurality of” (or multiple) means at least two, the term such as “greater than,” “less than,” “exceed” or variants thereof prior to a number or series of numbers is understood to not include the number adjacent to the term. The term “at least” prior to a number is understood to include the number adjacent to the term “at least,” and all subsequent numbers or integers that could logically be included, as clear from context. If used herein, the terms such as “first” and “second” are merely used for distinguishing technical features, and are not intended to indicate or imply relative importance, or implicitly point out the number of the indicated technical features, or implicitly point out the order of the indicated technical features.

The serial numbers assigned herein to components, such as “first,” “second,” etc., are merely used to distinguish the objects described and do not have any sequential or technical meaning. The terms such as “connect,” “couple,” and their variants in the present disclosure include direct and indirect connection (coupling) unless otherwise specified.

A recreational vehicle can provide a relatively comfortable travel or living environment for users, allowing the users to live in the recreational vehicle for a long time. Some recreational vehicles are equipped with batteries, so they can work independently without relying on external power supply, which is very useful in some travelling scenarios. In this case, the air conditioner of the recreational vehicle is the main electricity-consuming appliance, has high power, and easily consumes electricity in the battery, so it is not conducive to the user's long stay in the recreational vehicle. For example, the user intends to sleep in the recreational vehicle at night for about 8 hours. When the remaining charge of the battery is insufficient for the air conditioner to provide the user with 8 hours of cooling output, the user's sleep will be affected.

In view of the above, embodiments of the present disclosure provide a method for controlling operation of a vehicle air conditioner, a controller, an air conditioner, and a recreational vehicle. According to the schemes, a maximum operating power of the air conditioner is calculated according to a set operating duration and a remaining charge of a battery, so that operation of the air conditioner is limited according to the maximum operating power. Additionally, a real-time remaining charge of the battery is continuously monitored, and the maximum operating power is adjusted, such that the air conditioner can operate for the set operating duration and make full use of the remaining charge of the battery, thereby improving user experience.

The present disclosure will be described below in conjunction with the accompanying drawings.

Referring to FIG. 1, an embodiment of the present disclosure provides a method for controlling operation of a vehicle air conditioner, including following.

At S100, an operating instruction from a user is obtained. The operating instruction includes a set operating duration.

At S200, a first maximum operating power of the air conditioner is determined according to the set operating duration and a current remaining charge of a battery in the vehicle.

At S300, the air conditioner is controlled to operate within a range not exceeding the first maximum operating power.

At S400, a continuous operating duration of the air conditioner is recorded, and a real-time remaining charge of the battery is obtained. Additionally, a second maximum operating power of the air conditioner is determined according to the continuous operating duration and the real-time remaining charge, and the air conditioner is controlled to continue operating within a range not exceeding the second maximum operating power.

The air conditioner is arranged in the vehicle. A specific space in the vehicle is a working space of the air conditioner. The battery in the vehicle is configured to supply electricity to the air conditioner. In a case that there is no external power supply, the remaining charge of the battery is one of the factors that limit the operating duration of the air conditioner, and the operational status of the air conditioner is another factor that affects the operating duration of the air conditioner. In the embodiments of the present disclosure, to satisfy the user's long-time use of the vehicle air conditioner, the operational status of the air conditioner is limited according to the remaining charge of the battery and the set operating duration which is set by the user, such that the air conditioner can make full use of the remaining charge of the battery for operation.

For example, the air conditioner obtains an operating instruction from the user, which includes a set operating duration. The operating instruction may be set by the user through a remote controller, an onboard control panel, or the like. The operating instruction may be an instruction given by the user to set the set operating duration for the air conditioner when the air conditioner is on, or simultaneously set the set operating duration and a power-on instruction when the air conditioner is off. These settings constitute an operating instruction to be sent to the air conditioner. After receiving the set operating duration, the air conditioner determines a first maximum operating power of the air conditioner according to the current remaining charge of the battery in the vehicle and the set operating duration. During subsequent operation of the air conditioner, the air conditioner operates on the basis that the first maximum operating power is not exceeded. As such, the air conditioner can operate continuously for the set operating duration without being shut down due to insufficient electricity to affect user experience. It can be understood that the time for which the air conditioner can actually operate does not change linearly. In the process of the air conditioner operating with electricity of the battery, shutdown of the air conditioner when a set temperature is reached, reentering of the air conditioner into the cooling/heating mode, and the non-linear attenuation of the charge of the battery all affect the time for which the air conditioner can operate. In the present disclosure, not only the first maximum operating power of the air conditioner is calculated at an initial moment, but also a second maximum operating power of the air conditioner is calculated during the continuous operation of the air conditioner, such that the electricity of the battery is made full use. For example, the real-time remaining charge of the battery is obtained based on a time interval, and the second maximum operating power is calculated according to the duration for which the air conditioner has operated, such that the air conditioner is controlled not to exceed the second maximum operating power during subsequent operation. Therefore, the air conditioner can operate for the preset operating duration, make full use of the electricity of the battery, and provide a better user experience. The time interval based on which the real-time remaining charge of the battery is obtained may be set according to actual needs. For example, the real-time remaining charge of the battery is obtained every one hour or half an hour, and the continuous operating duration of the air conditioner is recorded every one hour or half an hour. A shorter time interval indicates a higher control precision. The time interval is not limited in the embodiments of the present disclosure.

It should be noted that application scenarios of the present disclosure are not limited to the recreational vehicle, and in other scenarios where a battery is configured to supply electricity to a vehicle, the method for controlling operation according to the present disclosure can also be used to control the air conditioner, to meet the user's requirement on the operating duration of the air conditioner.

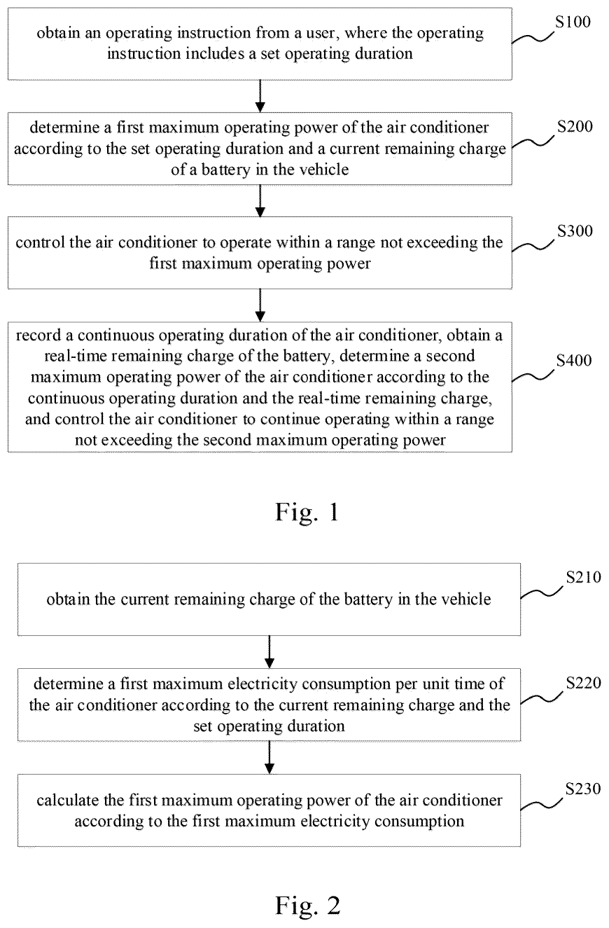

Referring to FIG. 2, the first maximum operating power determined in the S200 may be implemented by executing following.

At S210, the current remaining charge of the battery in the vehicle is obtained.

At S220, a first maximum electricity consumption per unit time of the air conditioner is determined according to the current remaining charge and the set operating duration.

At S230, the first maximum operating power of the air conditioner is calculated according to the first maximum electricity consumption.

The first maximum operating power is calculated as an initially calculated maximum operating power when the user starts setting the set operating duration. The current remaining charge of the battery may be evenly distributed into the set operating duration to obtain the first maximum electricity consumption per unit time of the air conditioner, so that the first maximum operating power of the air conditioner is calculated based on the first maximum electricity consumption per unit time. The unit time may be set according to actual needs. For example, if the set operating duration set by the user is Ns hours, the unit time may be 1 hour, and the calculated first maximum electricity consumption is the maximum electricity consumption of the air conditioner within 1 hour, so the air conditioner controls its operating power on a per-hour basis. The first maximum operating power may be obtained by directly dividing the first maximum electricity consumption by the unit time (e.g., 1 hour), or may be calculated by other operation methods (e.g., a weighting operation), which is not limited herein.

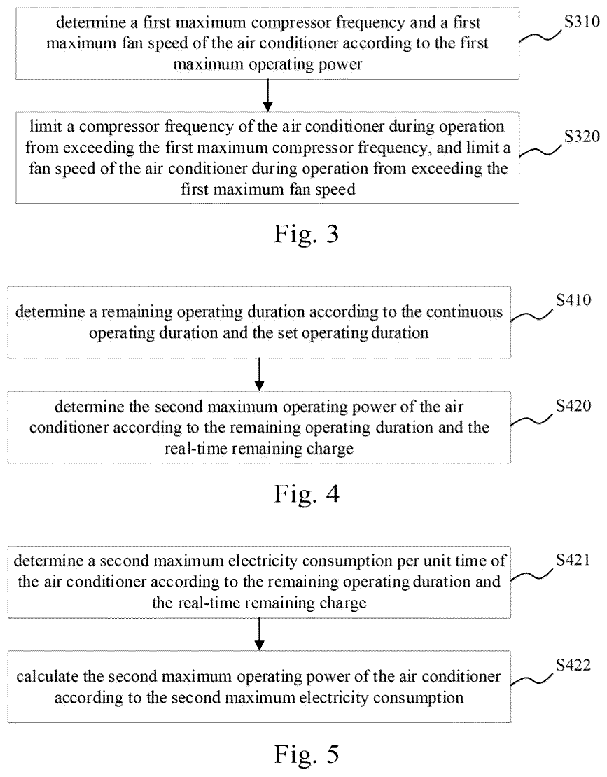

Referring to FIG. 3, controlling the air conditioner to operate within a range not exceeding the first maximum operating power in S300 may be implemented by executing following.

At S310, both a first maximum compressor frequency and a first maximum fan speed of the air conditioner are determined according to the first maximum operating power.

At S320, a compressor frequency of the air conditioner during operation is limited from exceeding the first maximum compressor frequency, and a fan speed of the air conditioner during operation is limited from exceeding the first maximum fan speed.

The first maximum compressor frequency and the first maximum fan speed during the operation of the air conditioner may be calculated according to the first maximum operating power. The compressor frequency and the fan speed are factors affecting the energy consumption of the air conditioner. The operating power of the air conditioner does not exceed the first maximum operating power by limiting the compressor frequency from exceeding the first maximum compressor frequency and limiting the fan speed from exceeding the first maximum fan speed, such that the electricity consumption of the air conditioner per unit time does not exceed the first maximum power consumption.

In addition to separately calculating the first maximum compressor frequency and the first maximum fan speed, the power of the compressor and the power of the fan may be controlled together based on the first maximum operating power. For example, in another embodiment, controlling the air conditioner to operate within a range not exceeding the first maximum operating power in S300 may include: controlling a sum of a compressor operating power and a fan operating power of the air conditioner not to exceed a first operating power threshold. The first operating power threshold is less than the first maximum operating power. In this case, the air conditioner obtains a real-time operating power of the compressor (i.e., the compressor operating power) and a real-time operating power of the fan (i.e., the fan operating power), calculates the sum of the compressor operating power and the fan operating power, and limits the sum of the compressor operating power and the fan operating power from exceeding the first operating power threshold during operation, thereby ensuring the operating duration of the air conditioner. It can be understood that there are other components in the air conditioner that operate at the same time in addition to the compressor and the fan, and these components require some operating power. Therefore, the first operating power threshold is less than the first maximum operating power. The first operating power threshold may be determined according to the first maximum operating power, for example, is set to 90% of the first maximum operating power, which is not limited herein.

In a case where the air conditioner operates at a power not exceeding the first maximum operating power, the air conditioner continues operating, and the maximum operating power of the air conditioner, i.e., the second maximum operating power in S400, is recalculated periodically. For example, referring to FIG. 4, determining a second maximum operating power of the air conditioner according to the continuous operating duration and the real-time remaining charge in S400 may include following.

At S410, a remaining operating duration is determined according to the continuous operating duration and the set operating duration.

At S420, the second maximum operating power of the air conditioner is determined according to the remaining operating duration and the real-time remaining charge.

The remaining operating duration of the air conditioner may be obtained by subtracting the duration for which the air conditioner has operated after receiving the operating instruction from the set operating duration initially set by the user, i.e., it is determined how long the air conditioner has to continue operating in the mode corresponding to the set operating duration. The second maximum operating power of the air conditioner within the remaining operating duration may be calculated according to the remaining operating duration and the real-time remaining charge of the battery. Based on the second maximum operating power, it is ensured that the air conditioner can make full use of the remaining charge of the battery, to avoid untimely exhaustion of the electricity or an excessively low maximum operating power.

Referring to FIG. 5, determining the second maximum operating power of the air conditioner according to the remaining operating duration and the real-time remaining charge in S420 may include following.

At S421, a second maximum electricity consumption per unit time of the air conditioner is determined according to the remaining operating duration and the real-time remaining charge.

At S422, the second maximum operating power of the air conditioner is calculated according to the second maximum electricity consumption.

The second maximum electricity consumption per unit time may be obtained by dividing the real-time remaining charge by the remaining operating duration, and the second maximum operating power of the air conditioner may be calculated based on the second maximum electricity consumption per unit time. The unit time may be set according to actual needs. For example, the unit time may be 1 hour, and the calculated second maximum electricity consumption is the maximum electricity consumption of the air conditioner within 1 hour, so the air conditioner controls its operating power on a per-hour basis. The second maximum operating power may be obtained by directly dividing the second maximum electricity consumption by the unit time (e.g., 1 hour), or may be calculated by other operation methods (e.g., a weighting operation), which is not limited herein.

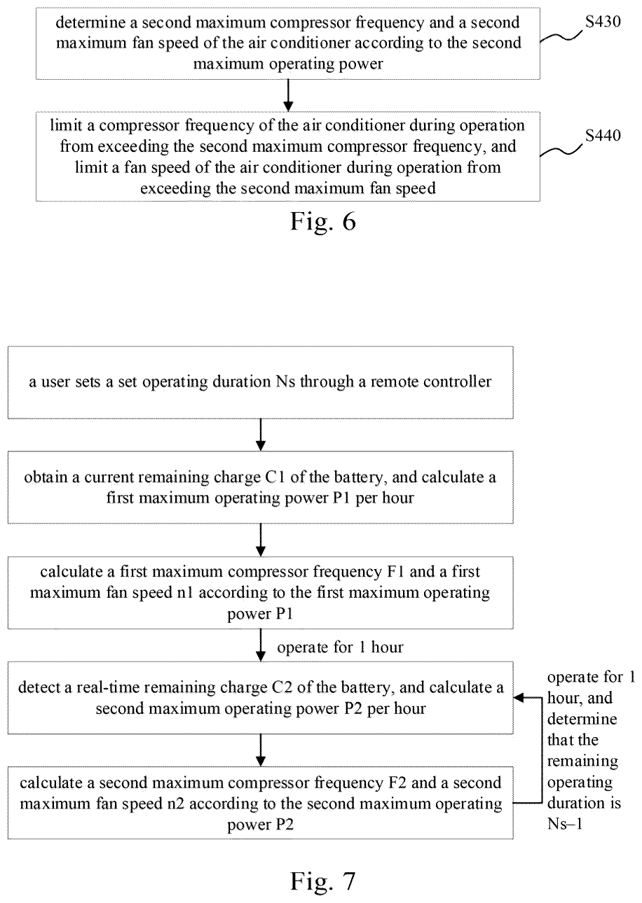

Referring to FIG. 6, controlling the air conditioner to continue operating within a range not exceeding the second maximum operating power in S400 may include following.

At S430, a second maximum compressor frequency and a second maximum fan speed of the air conditioner are determined according to the second maximum operating power.

At S440, a compressor frequency of the air conditioner during operation is limited from exceeding the second maximum compressor frequency, and a fan speed of the air conditioner during operation is limited from exceeding the second maximum fan speed.

The second maximum compressor frequency and the second maximum fan speed during the continuous operation of the air conditioner may be calculated according to the second maximum operating power. The compressor frequency and the fan speed are factors affecting the energy consumption of the air conditioner. The operating power of the air conditioner does not exceed the second maximum operating power by limiting the compressor frequency from exceeding the second maximum compressor frequency and limiting the fan speed from exceeding the second maximum fan speed, thereby ensuring that the electricity consumption of the air conditioner per unit time does not exceed the second maximum power consumption.

In addition to separately calculating the second maximum compressor frequency and the second maximum fan speed, the power of the compressor and the power of the fan may be controlled together based on the second maximum operating power. For example, in another embodiment, controlling the air conditioner to continue operating within a range not exceeding the second maximum operating power in S400 may include controlling a sum of a compressor operating power and a fan operating power of the air conditioner not to exceed a second operating power threshold. The second operating power threshold is less than the second maximum operating power. In this case, the air conditioner obtains a real-time operating power of a compressor (i.e., the compressor operating power) and a real-time operating power of a fan (i.e., the fan operating power), calculates a sum of the compressor operating power and the fan operating power, and limits the sum of the compressor operating power and the fan operating power from exceeding the second maximum operating power during operation, thereby ensuring the operating duration of the air conditioner. It can be understood that there are other components in the air conditioner that operate at the same time in addition to the compressor and the fan, and these components require some operating power. Therefore, the second operating power threshold is less than the second maximum operating power. The second operating power threshold may be determined according to the second maximum operating power, for example, is set to 90% of the second maximum operating power, which is not limited herein.

With the above method, the air conditioner not only determines the first maximum operating power when receiving the operating instruction, but also determines the second maximum operating power during the continuous operation after receiving the operating instruction. Therefore, the air conditioner can meet the requirement of the set operating duration, and adapt to the situations of shutdown of the air conditioner when a set temperature is reached and non-linear consumption of the charge of the battery during the continuous operation of the air conditioner, thereby providing a satisfactory user experience.

The method for controlling operation of a vehicle air conditioner will be described below through an example.

Referring to FIG. 7, an air conditioner is arranged in a recreational vehicle, and a battery inside the recreational vehicle is configured to supply electricity to the air conditioner. When a user in the recreational vehicle needs to turn on a cooling mode of the air conditioner to sleep in the recreational vehicle, the user sets a set operating duration Ns (using one hour as a smallest time unit) through a remote controller of the air conditioner, where Ns indicates a time length that the user wants the air conditioner to operate for.

After receiving an instruction carrying the set operating duration Ns, the air conditioner obtains a current remaining charge C1 of the battery, and evenly distributes the current remaining charge C1 of the battery into the set operating duration Ns, to obtain a first maximum electricity consumption per hour W1=C1/Ns of the air conditioner. Using one hour as a unit time, the first maximum operating power is P1=W1=C1/Ns.

A first maximum compressor frequency F1 of a compressor and a first maximum fan speed n1 of a fan of the air conditioner are calculated according to the first maximum operating power P1. The air conditioner limits a maximum frequency of the compressor and a maximum speed of the fan according to the first maximum compressor frequency F1 and the first maximum fan speed n1. In other words, the frequency of the compressor does not exceed F1 and the speed of the fan does not exceed n1 in any case, such that the actual operating power of the air conditioner is less than or equal to the calculated first maximum operating power P1. Therefore, it can be ensured that the electricity consumption per hour of the air conditioner is less than or equal to C1/Ns.

In the process of the air conditioner operating according to the first maximum operating power P1 for one hour, a phenomenon such as shutdown of the air conditioner when a set temperature is reached may occur depending on the actual environment. Therefore, the actual consumed power may be lower than the first maximum operating power P1, and the electricity consumption per hour may be lower than C1/Ns. To make full use of the remaining charge and increase the cooling capacity, the air conditioner detects a real-time remaining charge C2 of the battery starting from the second hour, and intelligently calculates a maximum electricity consumption per hour W2=C2/(Ns−1) based on an assumption that the air conditioner will continue operating for Ns−1 hours, i.e., calculates a second maximum electricity consumption W2. A second maximum operating power per hour P2=W2=C2/(Ns−1) may be calculated according to the second maximum electricity consumption W2.

A second maximum compressor frequency F2 of the compressor and a second maximum fan speed n2 of the fan of the air conditioner are calculated according to the second maximum operating power P2. The air conditioner limits the maximum frequency of the compressor and the maximum speed of the fan according to the second maximum compressor frequency F2 and the second maximum fan speed n2, such that the frequency of the compressor does not exceed F2 and the speed of the fan does not exceed n2 in any case. Therefore, it can be ensured that the actual operating power of the air conditioner is less than or equal to the calculated second maximum operating power P2, and the electricity consumption per hour of the air conditioner is less than or equal to C2/(Ns−1).

Similarly, the real-time remaining charge of the battery is obtained and the remaining operating duration is determined every one hour, so as to ensure that the air conditioner can operate for Ns hours, thereby making full use of the remaining charge of the battery, increasing the cooling capacity of the recreational vehicle air conditioner, and meeting the user's requirement on the operating duration of the air conditioner.

In addition, an embodiment of the present disclosure provides a controller, including a memory, a processor, and a computer program stored in the memory and executable by the processor, where the computer program, when executed by the processor, causes the processor to implement the method described above.

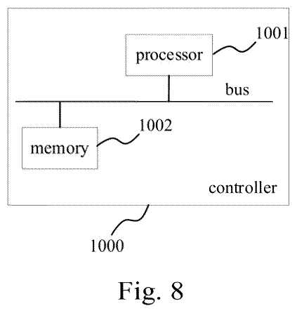

Referring to FIG. 8, for example, a control processor 1001 and a memory 1002 in a controller 1000 may be connected via a bus. The memory 1002, as a non-transitory computer-readable storage medium, may be configured to store a non-transitory software program and a non-transitory computer-executable program. In addition, the memory 1002 may include a high-speed random access memory, and may also include a non-transitory memory, e.g., at least one magnetic disk storage device, flash memory device, or other non-transitory solid-state storage device. In some implementations, the memory 1002 optionally includes memory located remotely from the control processor 1001, and the remote memory may be connected to the controller 1000 via a network. Examples of the network include, but not limited to, the Internet, an intranet, a local area network, a mobile communication network, and combinations thereof.

Those having ordinary skills in the art may understand that the apparatus structure shown in FIG. 8 does not constitute a limitation to the controller 1000, and the controller 1000 may include more or fewer components than those shown in the figure, or some components may be combined, or a different component arrangement may be used.

In addition, an embodiment of the present disclosure provides an air conditioner including the controller 1000. The controller executes the method described above to ensure that the air conditioner can operate for the set operating duration, thereby making full use of the remaining charge of the battery, increasing the cooling capacity of the recreational vehicle air conditioner and meeting the user's requirement on the operating duration of the air conditioner.

In addition, an embodiment of the present disclosure provides a computer-readable storage medium storing a computer-executable instruction which, when executed by one or more processors, for example, by a processor 1001 in FIG. 8, may cause the one or more processors to implement the method in the above method embodiments, for example, implement S100 to S400 in FIGS. 1, S210 to S230 in FIGS. 2, S310 to S320 in FIGS. 3, S410 to S420 in FIGS. 4, S421 to S422 in FIGS. 5, or S430 to S440 in FIG. 6.

The apparatus embodiments described above are merely examples. The units described as separate components may or may not be physically separated, i.e., they may be located in one place or may be distributed over a plurality of network nodes. Some or all of the modules may be selected according to actual needs to achieve the objects of the scheme of this embodiment.

Those having ordinary skills in the art can understand that all or some of in the methods disclosed above and the functional modules/units in the system and the apparatus can be implemented as software, firmware, hardware, and appropriate combinations thereof. Some or all physical components may be implemented as software executed by a processor, such as a central processing unit, a digital signal processor, or a microprocessor, or as hardware, or as an integrated circuit, such as an application-specific integrated circuit. Such software may be distributed on a computer-readable medium, which may include a computer-readable storage medium (or non-transitory medium) and a communication medium (or transitory medium). As well known to those having ordinary skills in the art, the term “computer-readable storage medium” includes volatile and nonvolatile, removable and non-removable media implemented in any method or technology for storage of information (such as computer-readable instructions, data structures, program modules, or other data). The computer-readable storage medium includes, but is not limited to, Random Access Memory (RAM), Read-Only Memory (ROM), Electrically Erasable Programmable Read-Only Memory (EEPROM), flash memory or other memory technology, Compact Disc Read-Only Memory (CD-ROM), Digital Versatile Disc (DVD) or other optical storage, a cassette, a magnetic tape, a magnetic disk storage or other magnetic storage device, or any other medium which can be used to store the desired information and can be accessed by a computer. In addition, as well known to those having ordinary skills in the art, the communication medium typically includes computer-readable instructions, data structures, program modules, or other data in a modulated data signal such as a carrier or other transport mechanism, and can include any information delivery medium.

Although some implementations of the present disclosure have been described above, the present disclosure is not limited to the implementations described above. Those having ordinary skills in the art can make various equivalent modifications or replacements without departing from the protection scope of the present disclosure. Such equivalent modifications or replacements fall within the protection scope defined by the claims of the present disclosure.

1-13. (canceled)

14. A control method comprising:
obtaining an operating instruction including a set operating duration;
determining a first maximum operating power of an air conditioner of a vehicle according to the set operating duration and a current remaining charge of a battery of the vehicle;
controlling the air conditioner to operate in a power range not exceeding the first maximum operating power;
recording a continuous operating duration of the air conditioner and obtaining a real-time remaining charge of the battery;
determining a second maximum operating power of the air conditioner according to the continuous operating duration and the real-time remaining charge; and
controlling the air conditioner to continue operating in a power range not exceeding the second maximum operating power.

15. The method of claim 14, wherein determining the first maximum operating power includes:
obtaining the current remaining charge of the battery;
determining a maximum electricity consumption per unit time of the air conditioner according to the current remaining charge and the set operating duration; and
calculating the first maximum operating power according to the maximum electricity consumption.

16. The method of claim 14, wherein controlling the air conditioner to operate in a power range not exceeding the first maximum operating power includes:
determining a maximum compressor frequency and a maximum fan speed of the air conditioner according to the first maximum operating power; and
controlling the air conditioner to operate with a compressor frequency not exceeding the maximum compressor frequency and a fan speed not exceeding the maximum fan speed.

17. The method of claim 14, wherein controlling the air conditioner to operate in the power range not exceeding the first maximum operating power includes:
controlling the air conditioner to operate with a sum of a compressor operating power and a fan operating power less than or equal to an operating power threshold less than the first maximum operating power.

18. The method of claim 14, wherein recording the continuous operating duration and obtaining the real-time remaining charge includes:
recording the continuous operating duration and obtaining the rea-time remaining charge at an interval of one hour.

19. The method of claim 14, wherein determining the second maximum operating power includes:
determining a remaining operating duration according to the continuous operating duration and the set operating duration; and
determining the second maximum operating power according to the remaining operating duration and the real-time remaining charge.

20. The method of claim 19, wherein determining the second maximum operating power of the air conditioner according to the remaining operating duration and the real-time remaining charge includes:
determining a maximum electricity consumption per unit time of the air conditioner according to the remaining operating duration and the real-time remaining charge; and
calculating the second maximum operating power according to the maximum electricity consumption.

21. The method of claim 14, wherein controlling the air conditioner to continue operating in the power range not exceeding the second maximum operating power includes:
determining a maximum compressor frequency and a maximum fan speed of the air conditioner according to the second maximum operating power; and
controlling the air conditioner to operate with a compressor frequency not exceeding the maximum compressor frequency and a fan speed not exceeding the maximum fan speed.

22. The method of claim 14, wherein controlling the air conditioner to continue operating in a power range not exceeding the second maximum operating power includes:
controlling the air conditioner to operate with a sum of a compressor operating power and a fan operating power less than or equal to an operating power threshold less than the second maximum operating power.

23. A non-transitory computer-readable storage medium storing one or more computer-executable instructions that, when executed by a processor, cause the processor to perform the method of claim 14.

24. A controller comprising:
a memory storing a computer program stored; and
a processor configured to execute the computer program to:
obtain an operating instruction including a set operating duration;
determine a first maximum operating power of an air conditioner of a vehicle according to the set operating duration and a current remaining charge of a battery of the vehicle;
control the air conditioner to operate in a power range not exceeding the first maximum operating power;
record a continuous operating duration of the air conditioner and obtain a real-time remaining charge of the battery;
determine a second maximum operating power of the air conditioner according to the continuous operating duration and the real-time remaining charge; and
control the air conditioner to continue operating in a power range not exceeding the second maximum operating power.

25. An air conditioner comprising:
a controller including:
a memory storing a computer program stored; and
a processor configured to execute the computer program to:
obtain an operating instruction including a set operating duration;
determine a first maximum operating power of the air conditioner according to the set operating duration and a current remaining charge of a battery of a vehicle carrying the air conditioner;
control the air conditioner to operate in a power range not exceeding the first maximum operating power;
record a continuous operating duration of the air conditioner and obtain a real-time remaining charge of the battery;
determine a second maximum operating power of the air conditioner according to the continuous operating duration and the real-time remaining charge; and
control the air conditioner to continue operating in a power range not exceeding the second maximum operating power.

26. The air conditioner of claim 25, wherein the processor is further configured to execute the program to, when determining the first maximum operating power:
obtain the current remaining charge of the battery;
determine a maximum electricity consumption per unit time of the air conditioner according to the current remaining charge and the set operating duration; and
calculate the first maximum operating power according to the maximum electricity consumption.

27. The air conditioner of claim 25, wherein the processor is further configured to execute the program to, when controlling the air conditioner to operate in a power range not exceeding the first maximum operating power:
determine a maximum compressor frequency and a maximum fan speed of the air conditioner according to the first maximum operating power; and
control the air conditioner to operate with a compressor frequency not exceeding the maximum compressor frequency and a fan speed not exceeding the maximum fan speed.

28. The air conditioner of claim 25, wherein the processor is further configured to execute the program to, when controlling the air conditioner to operate in the power range not exceeding the first maximum operating power:
control the air conditioner to operate with a sum of a compressor operating power and a fan operating power less than or equal to an operating power threshold less than the first maximum operating power.

29. The air conditioner of claim 25, wherein the processor is further configured to execute the program to, when recording the continuous operating duration and obtaining the real-time remaining charge:
record the continuous operating duration and obtain the rea-time remaining charge at an interval of one hour.

30. The method of claim 14, wherein determining the second maximum operating power includes:
determining a remaining operating duration according to the continuous operating duration and the set operating duration; and
determining the second maximum operating power according to the remaining operating duration and the real-time remaining charge.

31. The air conditioner of claim 30, wherein the processor is further configured to execute the program to, when determining the second maximum operating power of the air conditioner according to the remaining operating duration and the real-time remaining charge:
determine a maximum electricity consumption per unit time of the air conditioner according to the remaining operating duration and the real-time remaining charge; and
calculate the second maximum operating power according to the maximum electricity consumption.

32. The air conditioner of claim 25, wherein the processor is further configured to execute the program to, when controlling the air conditioner to continue operating in the power range not exceeding the second maximum operating power:
determine a maximum compressor frequency and a maximum fan speed of the air conditioner according to the second maximum operating power; and
control the air conditioner to operate with a compressor frequency not exceeding the maximum compressor frequency and a fan speed not exceeding the maximum fan speed.

33. A recreational vehicle comprising the air conditioner of claim 25.
